(19) United States
(12) Patent Application Publication
(10) Pub. No.: US 2004/0114035 A1
(43) Pub. Date: Jun. 17, 2004

(54) Focusing panel illumination method and apparatus

(76) Inventor: Timothy White, New Boston, NH (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/419,049

(22) Filed: Apr. 18, 2003

Related U.S. Application Data
(63) Continuation-in-part of application No. 09/046,761, filed on Mar. 24, 1998, now abandoned.

(51) Int. Cl. H04N 7/18; H04N 9/47

(52) U.S. Cl. 348/131

(57) ABSTRACT

A device for viewing an object is provided comprising a housing, a camera disposed in a housing for receiving an image of the object, focusing optics associated with the camera, an illumination source and a faceted focusing panel for reflecting illumination to the object in a large solid angle of illumination. Also provided is a method of providing an illumination source for an object, comprising determining the specularity of the object, determining an acceptable defect size in the uniformity of the illumination field, and providing an illumination geometry having defect size less than the acceptable defect size. Illumination geometries are provided that include a faceted reflecting panel.

### REFERENCE TO RELATED APPLICATIONS

This application is a continuation-in-part of U.S. application Ser. No. 09/046,761, filed Mar. 24, 1998, pending, the contents of which are incorporated by reference herein.

### FIELD OF THE INVENTION

The invention pertains to a focusing panel for illumination, and in particular to a focusing panel for illumination of a workpiece.

### DESCRIPTION OF THE RELATED ART

Electronic machine vision apparatuses are commonly employed in conjunction with automatic manufacturing, machining, assembly and inspection apparatuses, particularly of the robotics type. Observing apparatuses, such as television cameras, are commonly employed to observe the object being machined, assembled, or inspected, and the image received and signal transmitted by the camera can be compared to a standard image or signal stored in a database to determine if the observed article is properly machined, oriented, or assembled. Also, machine vision is widely used in inspection and flaw detection applications whereby inconsistencies and imperfection in both hard and soft goods can be rapidly ascertained and adjustments or rejections instantaneously effected.

When the object being observed has a shiny specular surface, reflections of non-uniformities in the local lighting environment may create misleading visual features that interfere with the accuracy of the inspection task, such as the appearance of a reflected shadow on a laser etched letter “I” causing it to appear to the machine vision apparatus as the letter “T”. In the inspection of soldered circuits such as used with printed circuit boards, the highly reflective nature and uneven surface geometry of the solder makes it very difficult to obtain an accurate electronic signal, and the same is true when machine vision is used to inspect laser etched metal surfaces, reflective packaging, and other objects having shiny surfaces, particularly irregular shiny surfaces.

In order to view a feature, image contrast is necessary between the feature and the underlying material. Specular surfaces require a specific illumination geometry to achieve the required image contrast for the features of interest, which is determined by the angle of viewing and the surface's geometry relative to the optical axis between the surface and the viewer. For normal viewing of a flat specular surface, i.e., a surface in which the optical axis is perpendicular to the surface being imaged and the surface is substantially a plane, the light source must have a width equal to at least twice the size of the object field of view plus the diameter of the camera aperture for a normal lens if the light source is integrated with the camera. This relationship is independent of distance from the light source to the surface being observed.

Uneven specular surfaces require a large solid angle of substantially uniform incident illumination to appear uniformly illuminated, depending on the degree of surface unevenness. A large solid angle of illumination is characterized by light striking the surface to be viewed over a large continuous range of incident angles. A solid angle of front illumination of 160° allows a specular surface with approximately ±40° of surface unevenness to appear uniformly illuminated. Additionally, substantially uniform incident illumination is defined herein as incident illumination having a brightness level that varies by less than approximately ±25% to 30% from a mean brightness value.

Illumination systems exist that produce illumination that is continuous and uniform in nature and is free of dark, bright or void portions capable of generating erroneous vision signals. Examples of such systems are disclosed in U.S. Pat. No. 5,684,530 and U.S. Pat. No. 5,461,417, each of which discloses a continuous diffuse illumination (“CDI”) method and apparatus. The disclosure of each of such U.S. Patents is incorporated by reference herein. CDI illumination provides dramatically improved results when machine vision is used to view shiny, irregular objects.

FIGS. 1-6 depict various illumination geometries that have been traditionally used in machine vision systems along with their associated incident angle brightness histograms. For example, in FIG. 1, a coaxial illumination system 1 is employed to illuminate object 2 as it is viewed by electronic machine vision camera 3. As can be seen from the incident angle brightness histogram shown in FIG. 2, this coaxial illumination system provides a uniform extended illumination zone 4 with a desirable incident illumination level that coincides with a zero angle of incidence off of the observation axis but is substantially devoid of any illumination as the angle of incidence deviates from zero.

FIG. 3 depicts an off-illumination axis diffuse dome lighting system 5 illuminating an object 2 to be observed by electronic machine vision camera 3 through an observation window 6, which can be an opening or orifice or even a zone of material that appears transparent to a machine vision camera, such as clear plastic or the like. This illumination system creates the uniform diffuse illumination zone 4 shown in FIG. 4. While the incident illumination level is substantially uniform as the angle of incidence of the light increases away from a zero angle of incidence off of the observation axis, the on-observation axis region 7, which has an angle of incidence approaching zero degrees off-axis, is substantially devoid of any illumination.

A ring illumination system and its corresponding incident angle brightness histogram, as depicted in FIGS. 5 and 6 respectively, provides a uniform diffuse illumination zone 4 with a substantially uniform incident illumination level that corresponds to substantially the same shape as the ring illuminator 8 being employed.

FIGS. 7, 8, 9, and 10 show two illumination systems and methods and their respective incident angle brightness histograms. First, FIG. 7 shows a continuous diffuse illumination system that is comprised of a combination of the coaxial illumination system 1 of FIG. 1 and the off-illumination axis diffuse illumination system 5 of FIG. 3. The combination of these two illumination components results in a lighting environment with the incident angle brightness histogram shown in FIG. 8. This environment is characterized by a diffuse illumination zone 4 with a substantially uniform incident illumination level irrespective of the angle of incidence.

When utilizing machine vision techniques, it is common to employ complicated lighting systems for illuminating the object being observed. Some such systems eliminate shadows, highlights, reflections and other lighting characteristics caused by shiny convex surface objects. Other systems provide increased contrast to images printed on dull, flat surfaces. Examples of complex lighting systems for use with machine vision apparatus are shown in U.S. Pat. Nos. 4,677,473; 4,882,498; 5,051,825; 5,060,065 and 5,072,127. The disclosure of such patents is incorporated by reference herein. The devices shown in these patents are capable of generating improved lighting characteristics. However, such devices may in some instances be too complex or expensive to manufacture relative to the benefit they provide. Also, some devices may require a relatively intense, expensive illumination source. Accordingly, a simple to manufacture device that provides adequate illumination of uneven specular surfaces at high-efficiency is desirable.

One application of machine vision utilizing an improved illumination source is an integrated video microscopy workstation. A video microscopy workstation may consist of a flat work surface and a super-positioned imaging/viewing module containing a camera, optics, a monitor and an illumination source. Poor lighting geometry of workstations provide an extremely small solid angle of illumination, creating generally poor image quality with undesirable glints and shadows on any specular object imaged.

### OBJECTS OF THE INVENTION

It is an object of the invention to provide a low-cost, high-efficiency illumination method and apparatus.

It is another object of the invention to provide a method and apparatus for illuminating an object to be observed by machine vision camera(s) wherein illumination of the object is by a faceted reflective focusing panel.

It is another object of the invention to provide a machine vision system in which an electronic machine vision camera is disposed in a housing for receiving an image of the object and transmitting a signal corresponding to the image. The machine vision system further comprises a light source and reflective focusing panel, wherein the focusing panel provides an illumination field that includes discontinuities that are defined to be sufficiently small to permit an accurate image of the object to be viewed.

It is another object of the invention to provide an illumination system that includes discontinuities that are not greater than a maximum size of discontinuity determined from the characteristics of the object to be viewed.

It is another object of the invention to provide an illumination system that provides a large solid angle of substantially uniform incident illumination to allow an object to be viewed to appear uniformly illuminated.

It is an object of the invention to provide a device for viewing an object comprising a housing, a camera disposed in a housing for receiving an image of the object, focusing optics associated with the camera, an illumination source and a faceted focusing panel for reflecting illumination to the object in a large solid angle of illumination.

It is an object of the invention to provide a method of providing an illumination source for an object, in which the method comprises determining the specularity of the object, determining an acceptable defect size in the uniformity of the illumination field, and providing an illumination geometry having defect size less than the acceptable defect size.

It is a further object of the invention to provide a method of image processing, comprising providing an illuminating source, providing a faceted focusing panel for reflecting light in a plurality of directions from the illumination source to an object to be viewed, providing an electronic camera for viewing the object, providing a vision processor for processing data from the electronic camera and providing a computer for storing, manipulating and retrieving data from the vision processor.

It is a further object of the invention to provide a vision system for viewing an object, comprising an electronic machine vision camera for receiving an image of an object and transmitting data corresponding to the image, an illumination source, a faceted focusing panel, for reflecting light in a plurality of directions from the illumination source to the object, an image processor, for receiving the data from the camera and generating data corresponding to the signal and a computer, for receiving, storing, manipulating and retrieving data from the image processor.

### SUMMARY OF THE INVENTION

The practice of the concepts of the invention are primarily utilized in machine vision applications with objects having specular surfaces, including machined or molded surfaces of convex or concave configurations and surfaces containing numerous convex and concave texture elements such as those found in materials such as embossed metal foil, matte-finish photographs and the like. However, it will be appreciated that the inventive concepts disclosed herein are also applicable to film camera, video camera, digital camera and microscope-aided human inspection systems, to line-scanning image sensors and photocopiers, and to other applications where proper illumination is required in order to obtain acceptable image quality.

The object to be machine vision observed, such as the solder of a printed circuit, a laser etched matrix code on a metal surface, or the like, is illuminated by a light source that is selected from a variety of available light sources that are disposed in different positions relative to the object. A number of different geometries for the present invention can be envisioned. In one such geometry, a panel is disposed along a plane above or below an object to be viewed and a light source.

In another geometry, the panel may include multiple reflecting surfaces that may have a variety of shapes and that may be arranged in a variety of geometric patterns to illuminate an area of interest on the object.

In another geometry, the panel may include a film that may have multiple segments that may have a variety of shapes and that may be arranged in a variety of geometric patterns to illuminate the area of interest. For example, the panel may include a hologram fabricated by using conventional holographic schemes.

According to one exemplary embodiment, a system for illuminating an area of interest may include a light source, a reflector for reflecting light from the light source onto an area of interest, and multiple reflecting surfaces disposed on the reflector and arranged in a geometric pattern such that light reflected therefrom converges onto the area to provide a solid angle of substantially uniform incident illumination sufficient to allow the area to appear uniformly illuminated.

According to another exemplary embodiment, a system for illuminating an area of interest may include a light source, a reflector for reflecting light from the light source onto an area of interest, and a film disposed on the reflector, the film having multiple segments arranged in a geometric pattern such that light reflected from the reflector through the multiple segments converges onto the area to provide a solid angle of substantially uniform incident illumination sufficient to allow the area to appear uniformly illuminated.

According to one exemplary embodiment, a method of illuminating an area of interest may include identifying an area of interest, providing a light source, and providing a reflector for reflecting light from the light source onto the area of interest, the reflector including multiple reflecting surfaces arranged in a geometric pattern such that light reflected therefrom converges onto the area to provide a solid angle of substantially uniform incident illumination sufficient to allow the area to appear uniformly illuminated.

According to another exemplary embodiment, a method of illuminating an area of interest may include identifying an area of interest, providing a light source, and providing a reflector for reflecting light from the light source onto the area of interest, the reflector including a film including multiple segments arranged in a geometric pattern such that light reflected from the reflector through the segments converges onto the area to provide a solid angle of substantially uniform incident illumination sufficient to allow the area to appear uniformly illuminated.

According to one exemplary embodiment, a method of fabricating reflecting surfaces for illuminating an area of interest may include providing reflecting surfaces and shaping the reflecting surfaces such that light reflected from the reflecting surfaces converges onto the area to provide a solid angle of substantially uniform incident illumination sufficient to allow the area to appear uniformly illuminated.

As will be appreciated from the following description, the apparatus permitting the practice of the invention is relatively simple and inexpensive as compared with prior art devices incapable of providing variable illumination conditions, including continuous diffused illumination conditions.

### BRIEF DESCRIPTION OF THE DRAWINGS

The aforementioned objects and advantages of the invention will be appreciated from the following description and accompanying drawings wherein:

FIGS. 1, 3 and 5 depict traditional illumination geometries used in conjunction with machine vision systems, namely coaxial Illumination, off-axis diffuse illumination, and ring illumination respectively;

FIGS. 2, 4 and 6 depict Incident Angle Brightness Histograms, which are graphs plotting incident illumination level as a function of angle of incidence, associated with the lighting geometries depicted in FIGS. 1, 3 and 5 respectively;

FIGS. 7 and 9 depict two embodiments of Continuous Diffuse Illumination geometries;

FIGS. 8 and 10 depict the Incident Angle Brightness Histograms associated with the lighting geometries depicted in FIGS. 7 and 9 respectively;

FIG. 11 is a schematic cross-sectional view of a basic apparatus permitting the practice of the invention, wherein illumination is provided by a combination of a light source and a faceted focusing panel;

FIG. 12 is a schematic depiction of an embodiment of the invention wherein the focusing panel is moveable;

FIG. 13 is a schematic depiction of an embodiment of facets of the focusing panel of the present invention;

FIGS. 14 through 16 are schematic depictions of the calculation of the angles of a light ray from the illumination source as reflected from the focusing panel and the object.

FIG. 17A is a side view of an illumination system including the focusing panel shown in FIG. 13, illustrating the generated illumination field.

FIG. 17B is a perspective view of a portion of the focusing panel of FIG. 17A taken along the line C-C.

FIGS. 18A, 18B, and 18C illustrate the reflective properties of ellipses.

FIG. 19A is a side view of an illumination system including a focusing panel in accordance with one embodiment of the present invention, illustrating the generated illumination field.

FIG. 19B is a perspective view of a portion of the focusing panel of FIG. 19A taken along the line A-A.

FIG. 19C is another perspective view of the focusing panel of FIG. 19A, illustrating the reflective surface.

FIG. 20A is a side view of an illumination system including a focusing panel in accordance with one embodiment of the present invention.

FIG. 20B is a perspective view of the focusing panel of FIG. 20A, illustrating the reflective surface.

FIG. 21 is a side view of an illumination system including a focusing panel in accordance with one embodiment of the present invention.

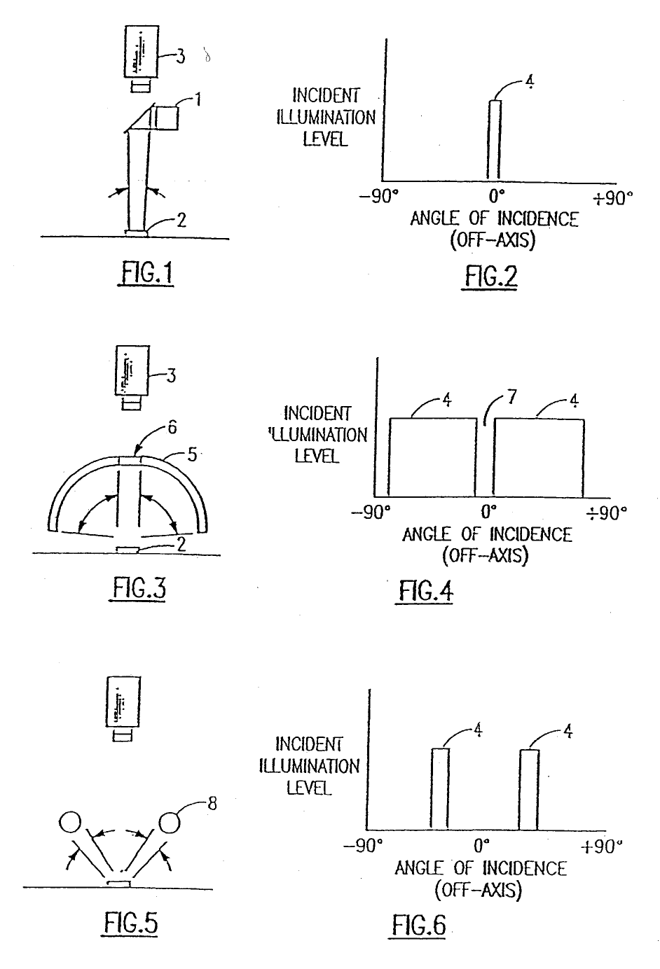

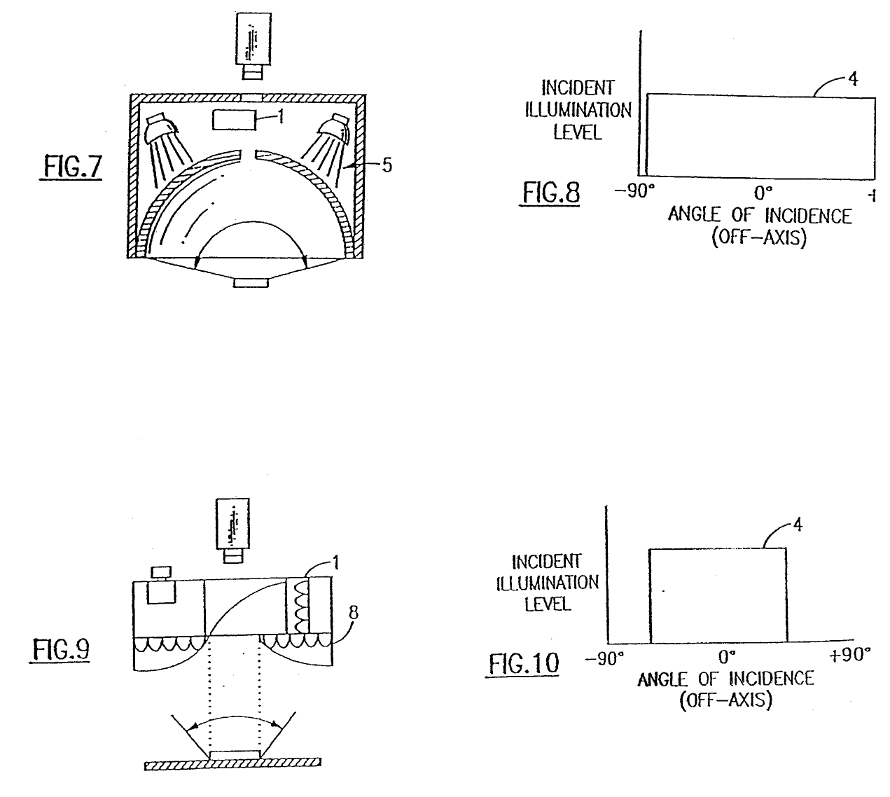

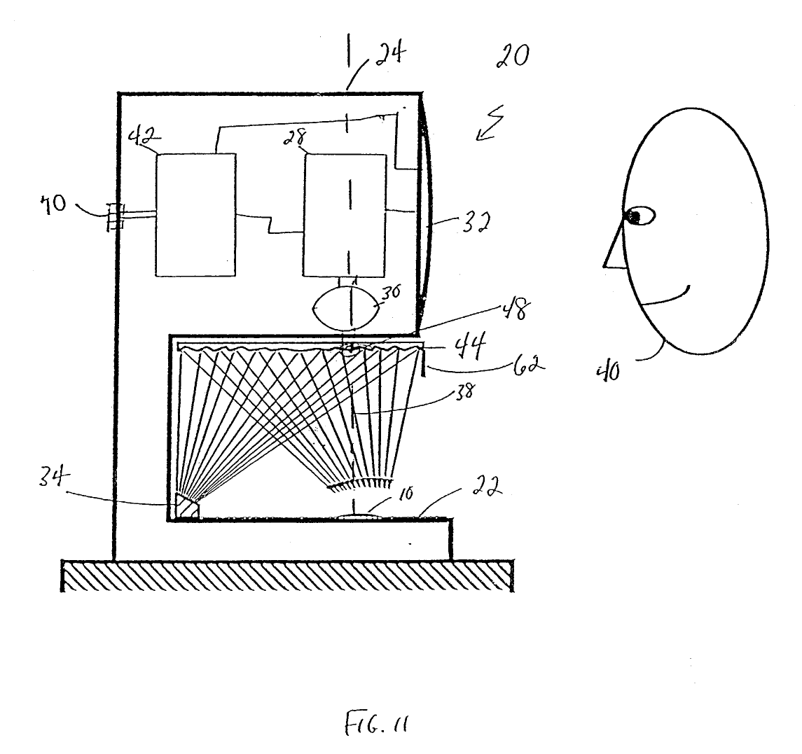

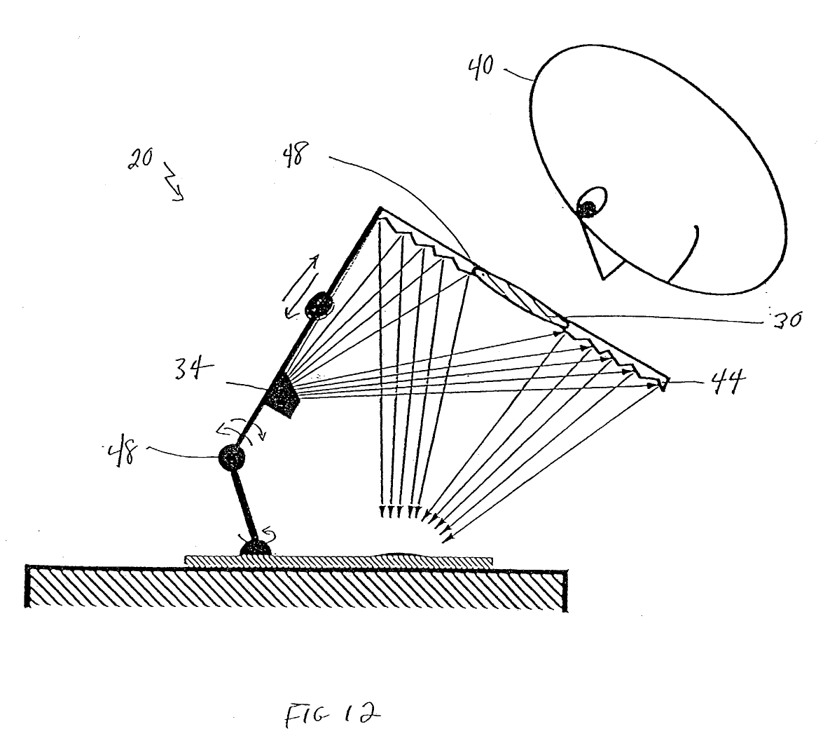

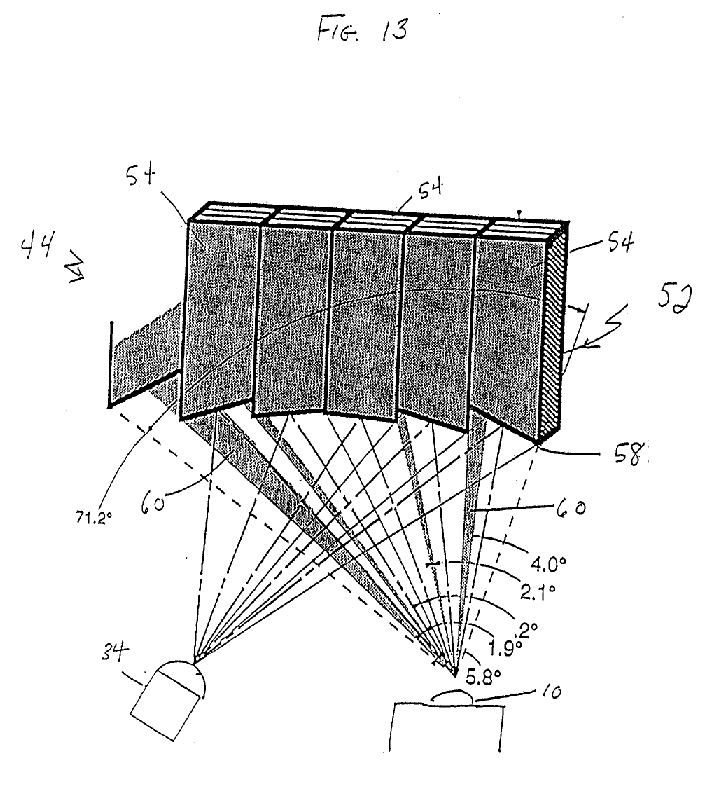

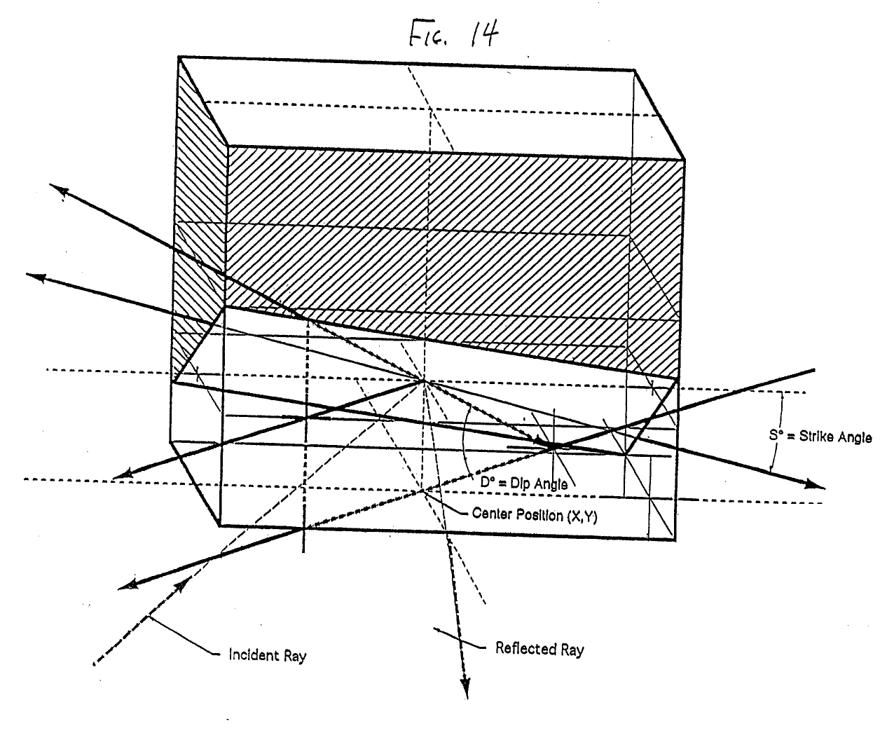

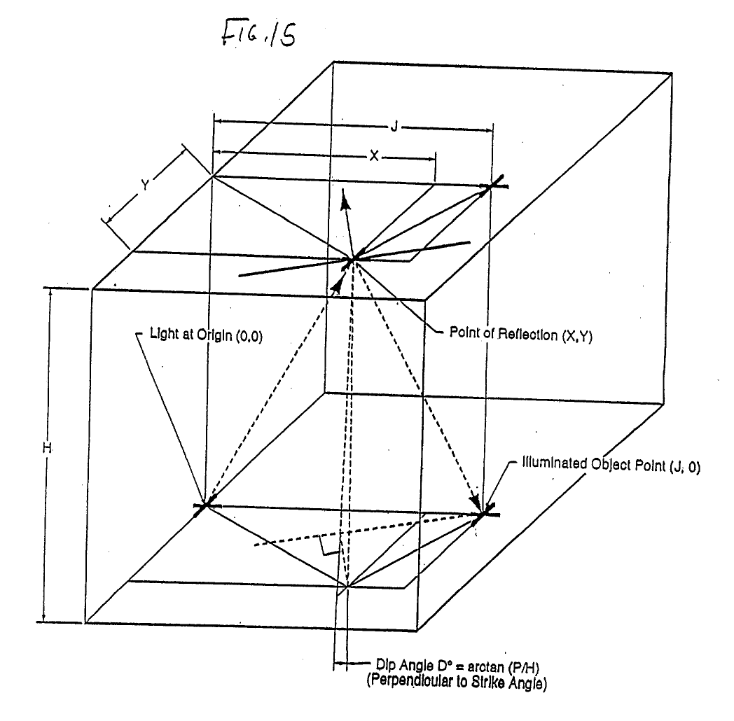

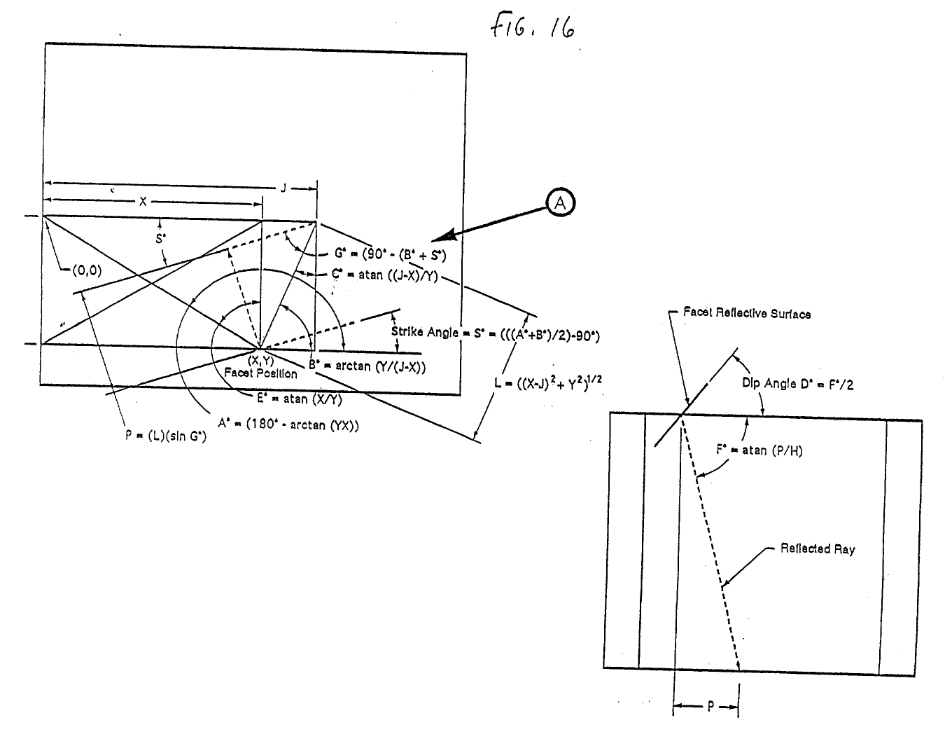

### DETAILED DESCRIPTION OF THE INVENTION

FIG. 11 depicts a simplified, cross-sectional schematic arrangement of components illustrating one embodiment of the inventive concepts, wherein the object to be viewed by a machine vision television camera 28 is indicated at 10. The object 10, which, in the practice of the invention, could include a shiny or specular surface, such as the soldered surfaces of a printed circuit board, or a laser etched metal surface, reflective packaging surface, or the like, a dull surface, such as copy paper, a flat surface, such as paper, or an irregular or non-flat configuration, is viewed by the camera 28. The viewing of the object 10 by the camera 28 occurs along the observation axis 38 as indicated in FIG. 11.

The purpose of viewing the object 10 by the camera 28 may be for any purpose requiring machine vision inspection, ranging from reading of a matrix code or bar code or character string to inspection for flaws, for instance, on the face of a fiber optic ferrule. Observation may be for any desired reason, such as for purposes of machining orientation or assembly prior to subsequent machining operations, or reading or reproducing printed, inscribed or chemical or laser etched art work or print. Significant variations in the local intensity of light reflected from an uneven specular surface will result only from localized surface slope deviations from flatness greater than half the incident illumination angle with respect to the optical axis, such as are commonly associated with surface imperfections, and not from less severe normal deviations in surface geometry that are not associated with defect conditions.

In the embodiment of the invention depicted in FIG. 11, a video microscopy workstation 20 may consist of a flat work surface 22, a super-positioned imaging/viewing module 24 containing the camera 28, optics 30, a monitor 32 and an illumination source 34. The optics 30 are positioned above the work surface 22, so that an object 10 positioned on the work surface 22 can be viewed substantially along the viewing axis 38 by the camera 28. An observer 40 may view the object through the monitor 32, which displays the output of the camera 28. The device may include a vision processor 42 for processing the output of the camera 28. The vision processor 42 may provide output to the monitor 32 or to an external workstation for use of data from the vision processor 42 that corresponds to images viewed by the camera 28 through the optics 30.

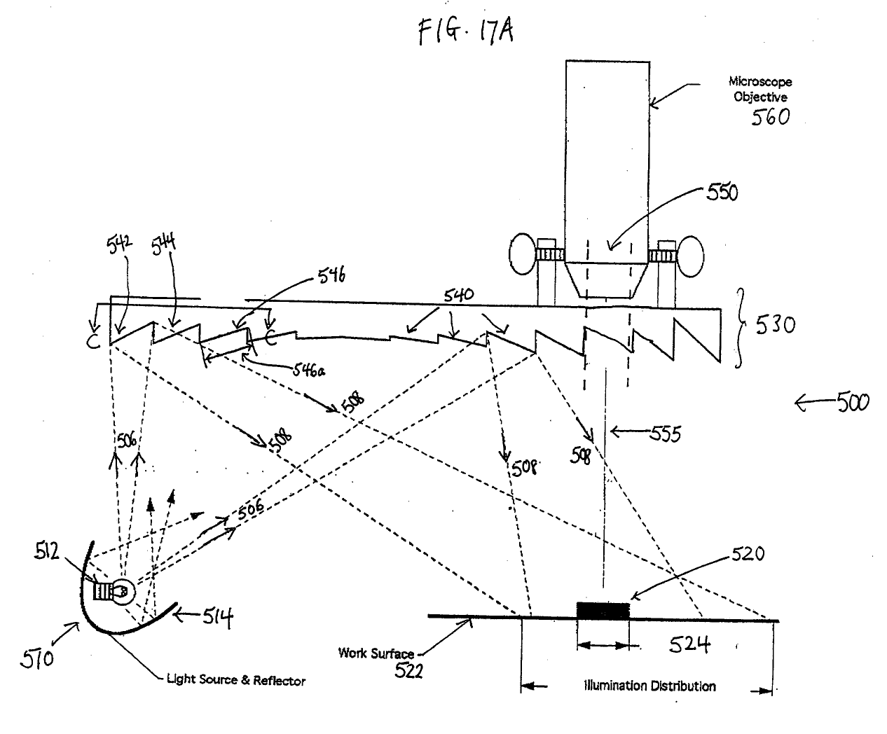

Referring to FIG. 11, illumination of the object 10 may be accomplished by reflection of light from an illumination source 34. Reflection is from a focusing panel 44 that is positioned to reflect light from the illumination source onto the object 10. In the embodiment of FIG. 11, the illumination source is positioned substantially on the plane defined by the work surface 22, on which the object 10 is located, so that the focusing panel 44 is positioned substantially in a plane that is above and substantially parallel to the work surface 22. The focusing panel 44 includes an aperture 48 that permits the optics 30 to view the object 10. The focusing panel 44 and the illumination source 34 may be positioned in a number of different relative locations, all capable of directing light to the object 10. For example, as depicted in FIG. 12, the focusing panel 44 and the illumination source 34 are both fixed onto a moving platform 50, so that the observer 40 can move the platform 50 to obtain a variety of viewing angles and distances. As can be seen in FIG. 12, the focusing panel 44 can be used with optics 30 in the form of a simple lens, without use of a camera, vision processor, monitor or other vision processing equipment. It should be noted that the moving platform 50 depicted in FIG. 12 could also be used in connection with the camera 28, vision processor 42, monitor 32 and other elements of the imaging module 24 of FIG. 11. The moving platform 50 may be designed to provide linear or angular movement of the focusing panel 44 relative to the object 10.

In an embodiment of the invention, the focusing panel 44 may be a flat, molded, faceted reflector panel that is disposed on the underside of the imaging module 24. The focusing panel may be constructed from a variety of materials, for example, plastic, metal, or other materials suitable for optical applications. The illumination source 34 is a single light source positioned behind and at the level of the object 10. Each facet on the focusing panel 44 would be angled to reflect the light source down toward the inspection area. The focusing panel 44 would therefore capture a large fraction of the output of the light source and reflect it focused down onto the inspection area, effectively forming a large solid angle of illumination with a solid angle on the order of 90°. This solid angle is significantly larger than that provided by a co-axial lighting geometry.

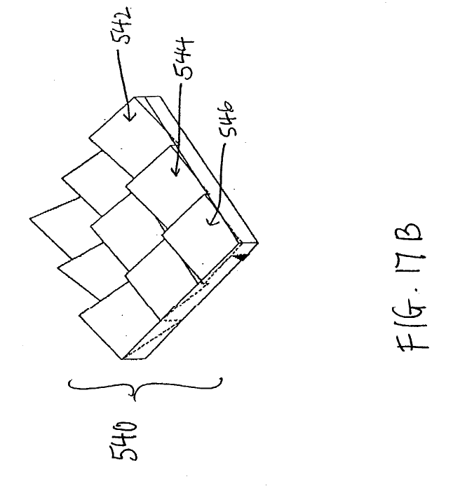

The faceted focusing panel 44 could be made by a variety of means. For example, it may be vacuum-formed over a mold. Referring to FIG. 13, a mold 52 could be formed as an array of square pins 54 made from ordinary rod stock, each pin ground flat and polished on one end at an appropriate angle and orientation. The reflector material on the focusing panel 44 could be any reflective material. In an embodiment the material may be a thermo-formed plastic sheet 58 of suitable thickness, for example, from approximately 0.1 mm to approximately 2 mm. Additional stiffness could be provided, in one method, by a folded rim on the reflector.

In an embodiment of the invention using the mold pins 54, each pin would be individually ground flat at a precise angle and orientation. For example, an 8″×12″ reflector panel consisting of ¼″ square facets might require approximately 1,500 individually ground mold pins. A computer numeric controlled (CNC) machine could be programmed to automatically cut the pins out of continuous stock. It would be important to keep track of different pin types after shaping. Alternatively, the entire reflector array of the focusing panel 44 could be designed on a computer and formed by using one or more fabricating processes including, for example, CNC machining, Electron Discharge machining (EDM), or stereo lithography.

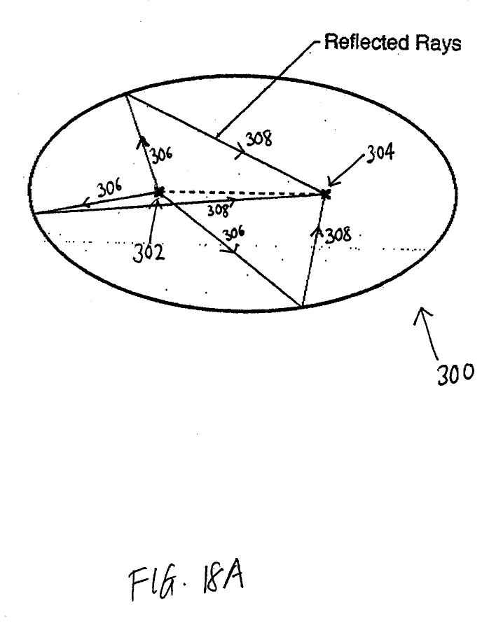

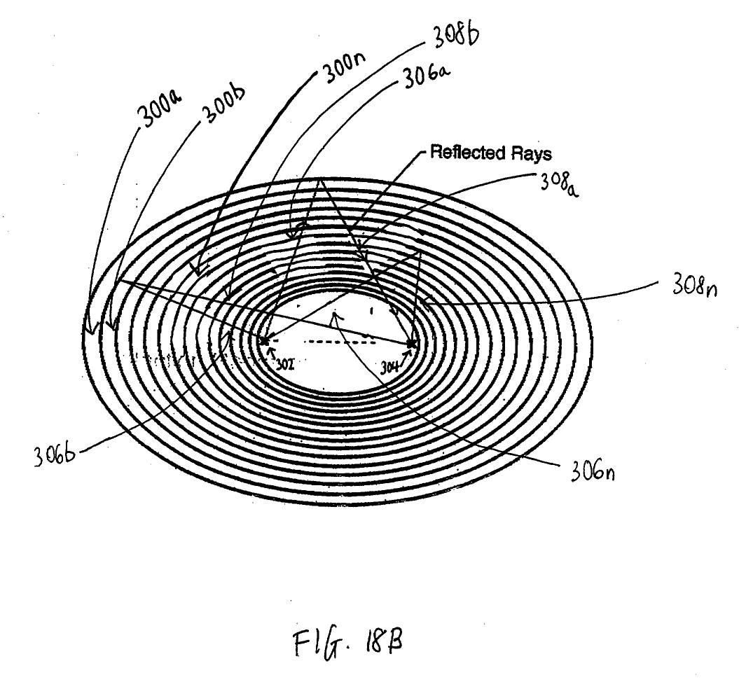

Referring to FIGS. 13 through 16, the angle and orientation of each facet in the focusing panels 44 can be calculated according to a geometric analysis. The angle of the surface of the mold pin 54 can be determined, as can the angle of the light striking from the illumination source 34. Light from the light source 34 is reflected from the surface of the focusing panel 44 at an angle equal to the angle of incidence. Since the mold pins 54 are designed to provide a wide variety of different surface angles, relative to the light source, light is reflected toward the object 10 at a wide variety of angles. Because of the large number of reflecting facets and assuming the possibility of a relatively large target size, e.g., one to two inches in diameter, for the reflected illumination source 34, as well as the proximity of the inspection area to the focusing panel 44, surface angle errors of a degree or more introduced by molding or positioning errors would have relatively little effect on the overall illumination quality.

Virtually any kind of illumination source 34 can be used with the proposed reflective focusing panel, including such simple sources as a small array of LED's, a single incandescent or short fluorescent bulb, or a fiber optic source. The device may include an eye shield 62 to protect the eyes of the observer 40.

The illumination field created by the focusing panel 44 will be effectively continuous through a solid angle of illumination, except for any void cut into it for the observing aperture 48. There will be small voids 60 in the illumination field caused by partial vignetting of each facet by its neighboring facet. The voids are represented by the shaded areas in FIG. 13A. The voids are increasingly significant at greater distances from the focusing panel 44. With ¼″ mold pins, these small vignetting voids will have a solid angle of typically a fraction of a degree, and would therefore be effectively invisible in a typical imaging situation with a less-than-mirror-like surface finish and significant camera lens aperture size by being out-of-focus when viewed reflected in the surface.

The specified angular dimension of the vignetting voids 60 can be reduced by reducing the size of the mold pins 54, allowing the inherent voids of a flat faceted focusing panel 44 to be made imperceptible to the observer for any given combination of surface specularity on the object 10 being viewed, depth of focus of the imaging optics 30, and sensitivity of the image processor 42 hardware and software to small fluctuations in background uniformity.

Larger-scale voids in the panel reflector due to the observing aperture 48 will be relatively small in the case of an illuminator for a standard binocular inspection microscope (1″×⅜″), but may be larger in other applications, such as retrofit of the focusing panel onto existing systems, such as, for example, a microscopy station provided by VTEK, where a 2″ diameter aperture is required. In such cases, a secondary light source such as a diffuse on axis light (DOAL) could be added to more closely approximate a CDI illuminator.

A single source may also create a non-uniform intensity across the illumination field it produces, which produces similar non-uniformity in the light reflected to and from the object 10. For simplicity and cost reasons it may in some instances be highly desirable to use a single off-axis light source for illumination of an object, notwithstanding the fact that use of a single source with a faceted reflecting panel creates some non-uniformity in the illumination field. It is possible to identify applications for which a pre-determined non-uniformity would either not matter or could be corrected by suitable “dimming” of the central reflector facets, either by altering their geometry or surface reflectivity to yield the desired degree of uniformity across the field. That is, based on the typical size, shape and specularity of the type of object to be viewed, the user can determine an acceptable defect size in the uniformity of the illumination field. Having determined the acceptable defect size, one can construct an illumination geometry that provides illumination at least as uniform as required for the application.

It is possible to obtain, if desired, the benefits of large solid angles of substantially uniform incident illumination in the illumination marketplace using a point source in conjunction with focused reflecting panel 44 despite the fact that the resulting illumination field is discontinuous on a fine scale. Extreme savings in cost, form factor and complexity for a light source, and hence greatly enhanced marketability of the resulting product, follow directly from the ability to specify an appropriate scale of non-uniformity within an otherwise uniform illumination field.

In order to identify the appropriate lighting source and geometry for a particular application, it is necessary first to specify an allowable degree of illumination non-uniformity for any given application.

In addition to free-standing work-piece illumination applications, the focusing panel illumination system can be used with machine vision systems and associated manufacturing and material handling processes, providing high-quality illumination at low cost where ever it is needed.

Other illumination geometries may be provided, including a faceted dome reflector or a continuous diffuse illumination system, in which defects in the illumination field may be identified and kept to a defect size lower than the acceptable defect size for a particular application.

A method of providing an illumination source for an object, comprises determining the specularity of the object, determining an acceptable defect size in the uniformity of the illumination field; and providing an illumination geometry having defect size less than the acceptable defect size.

The purpose of viewing the object 10 by the camera 28 may be for any purpose requiring visual inspection, including machine vision inspection, ranging from reading of a matrix code or bar code or character string to inspection for flaws, for instance, on the face of a fiber-optic ferrule. In an embodiment of the invention, the device 20 is a reader of matrix codes that encode various information about products, such as inventory numbers, product types, prices and the like. In another embodiment, the device 20 is a video microscopy workstation. In other words, observation may be for any desired reason, such as for purposes of machining orientation or assembly prior to subsequent machining operations, reading or reproducing printed, inscribed or chemical or laser etched art work or print, inspection of microscopic objects, or the like. The concepts of the invention are particularly suitable for code reading, flaw detection or inspection of specular objects that require substantially uniform lighting of the object 10.

The data from the device 20 may be transmitted, via a connector 70, or by other transmission mechanisms, such as infrared, radio, or other mechanism, to an external computer or computers which may be part of other systems and apparatuses that are responsive to image data. Such systems can include process control systems, manufacturing systems, inventory management systems, material handling systems, robotic arms, or any other robotic or machine vision systems. Thus, the device 20 may be integrated into any other device that is responsive to imaging data.

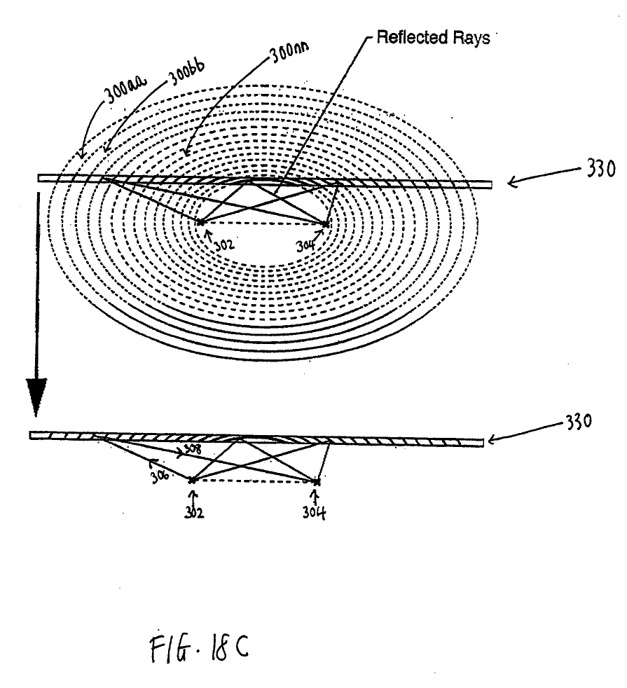

FIG. 17A shows the illumination field generated by an illumination system including the focusing panel shown in FIG. 13, and FIG. 17B shows a perspective view of a portion of the focusing panel of FIG. 17A taken along the line C-C. As shown in FIGS. 17A and 17B, an illumination system 500 may include a light source 510, an area of interest 520 located on a worksurface 522, and a focusing panel 530 including multiple flat reflecting surfaces 540, 542, 544, 546 for reflecting light from the light source 510 onto the area of interest 520.

In the embodiment shown in FIG. 17A, the focusing panel 530 may include an aperture 550 (schematically indicated by dotted lines) for viewing the area of interest 520 along an axis of observation 555 that extends through the aperture 550. Optionally, the illumination system 500 may include optics for observing the area of interest 520. For example, as shown, the illumination system 500 may include a microscope objective lens 560.

In the embodiment shown in FIG. 17A, the illumination system 500 illuminates the area of interest 520 on the worksurface 522. A variety of areas of interest 520 may be illuminated with the illumination system 500. For example, the area of interest 520 may include an object, such as one or more of the objects previously described, or a portion of an object.

In the embodiment shown in FIG. 17A, the light source 510 may include a light bulb 512 and a concave reflector 514. A variety of other light sources may be used with the illumination system 500. For example, the light source 510 may include one or more of the light sources previously described.

In the embodiment shown in FIG. 17A, the light source 510 may be disposed on a plane that is substantially coplanar with the plane defined by the worksurface 522. The light source 510 may be positioned at a variety of other locations. For example, as described in greater detail below, the light source 510 may be disposed on a moveable platform, and may be selectively positioned on a plane that extends substantially parallel to the plane defined by the worksurface 522. The light source 510 may be disposed on a plane that extends above or below the plane defined by the worksurface 522.

In the embodiment shown in FIG. 17A, the multiple flat reflecting surfaces 540 may be arranged in the substantially rectangular pattern previously described. In this embodiment, light rays 506 that emanate from the light source 510 and that strike the focusing panel 530 can be reflected as light rays 508 by the multiple reflecting surfaces 540. The reflected light rays 508 provide a substantially uniform level of illumination of the area of interest 520.

As shown in FIGS. 17A and 17B, the focusing panel 530 may include one or more reflecting surfaces 540, 542, 544, 546 having an appropriate angle and orientation for reflecting illumination from the light source 510 to the area of interest 520. Alternately, as described below, the focusing panel 530 may include one or more concave reflecting surfaces (not shown) for reflecting illumination from the light source 510 onto the area of interest 520.

As shown in FIG. 17A, the focusing panel 530 may include one or more flat reflecting surfaces 546 having a width 546a so that reflected light rays 508 extend at least across the width 524 of the area of interest 520. As shown in the figure, in this embodiment, the focusing panel 530 generates a focused distribution of reflected illumination across the area of interest 520.

As indicated above, the focusing panel may include multiple reflecting surfaces that may have a variety of shapes and that may be arranged in a variety of geometric patterns to illuminate an area of interest on the object being viewed. For example, as shown and described above in reference to FIGS. 11-13 and 17, the multiple reflecting surfaces may be flat. Alternately, as described below, the multiple reflecting surfaces may include a curvature. As also shown and described above in reference to FIGS. 11-13 and 17, the multiple reflecting surfaces may be arranged in a substantially rectangular pattern. Alternately, as described below, the multiple reflecting surfaces may be arranged in a substantially ellipsoidal pattern, a substantially concentric pattern, or a substantially concentric ellipsoidal pattern.

A variety of geometric terms are now described to facilitate the presentation of the geometric features and reflective properties of the arrangements specified above. A circle is a planar geometric curve that may be defined as the set of all points in a plane for which the distance from each point to a fixed point is constant. The fixed point may be referred to as the center. An unlimited number of circles sharing a common center may be constructed; these circles may be referred to as concentric circles. An ellipse is a planar geometric curve that may be defined as the set of all points in a plane for which the sum of the distances from each point to two fixed points is constant. The two fixed points may be referred to separately as the first focus and the second focus and collectively as the foci. An unlimited number of ellipses sharing common foci may be constructed; these ellipses may be referred to as concentric ellipses. An ellipsoid is a geometric surface whose planar sections are all ellipses or circles.

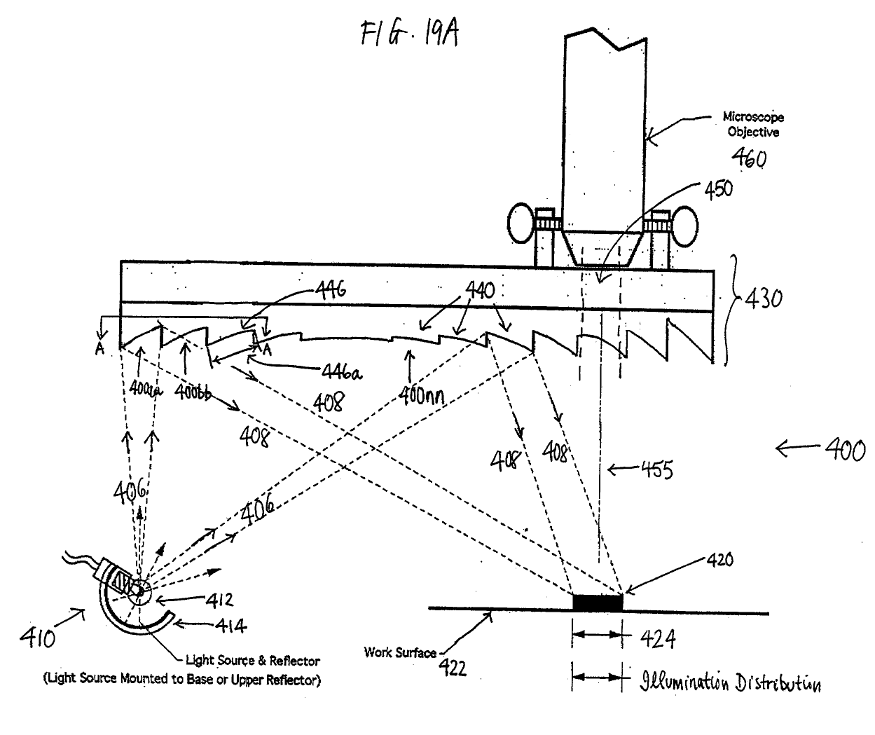

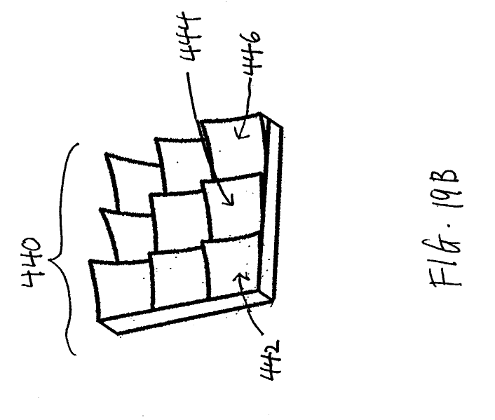

FIG. 18A shows a reflecting ellipse 300 having a first focus 302 and a second focus 304. As shown in FIG. 18A, a light ray 306 that emanates from the first focus 302 and that strikes the ellipse 300 can be reflected as light ray 308 by the ellipse 300. The reflected light ray 308 will pass through the second focus 304. As such, the first focus 302 may be referred to as the point of divergence, and the second focus 304 may be referred to as the point of convergence.

FIG. 18B shows a series of concentric reflecting ellipses 300a, 300b, 300n sharing common foci 302, 304. As shown in FIG. 18B, light rays 306a, 306b, 306n that emanate from the first focus 302 and that strike corresponding ellipses 300a, 300b, 300n can be reflected as light rays 308a, 308b, 308n by the corresponding ellipse 300a, 300b, or 300n. The reflected light rays 308a, 308b, 308n will pass through the second focus 304.

FIG. 18C shows a collapsed ellipsoid reflector 330 having foci 302, 304 that may be constructed based on the properties of reflecting ellipses. As shown in FIG. 18C, the collapsed ellipsoid reflector 330 may be constructed by slicing through a series of substantially concentric ellipsoid reflectors 300aa, 300bb, 300nn sharing common foci 302, 304. As also shown in FIG. 18C, a light ray 306 that emanates from the first focus 302 and strikes the collapsed ellipsoid reflector 330 can be reflected as light ray 308 by the collapsed ellipsoid reflector 330. The reflected light ray 308 will pass through the second focus 304.

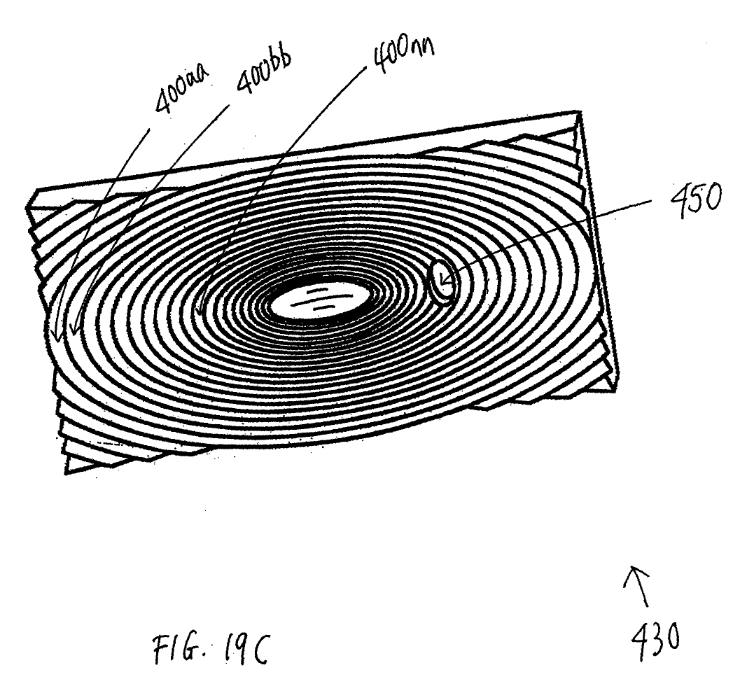

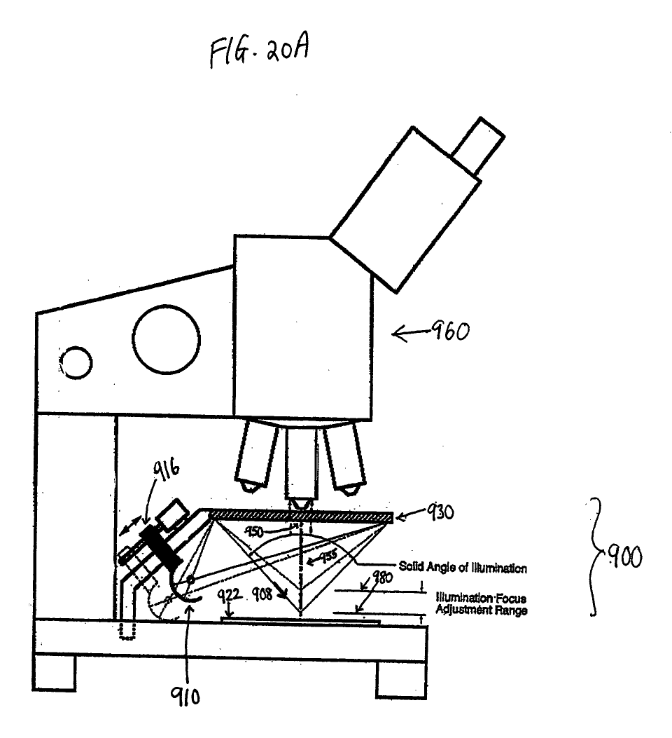

FIG. 19A shows a side view of an illumination system including a focusing panel in accordance with one embodiment of the present invention, and FIG. 19B shows a perspective view of a portion of the focusing panel of FIG. 19A taken along the line A-A. As shown in FIG. 19A, an illumination system 400 may include a light source 410, an area of interest 420 located on a worksurface 422, and a collapsed ellipsoid reflector 430 positioned to reflect light from light source 410 onto the area of interest 420. As also shown in FIG. 19A, the collapsed ellipsoid reflector 430 may include multiple substantially concentric ellipsoid reflectors 400aa, 400bb, 400nn. As shown in FIGS. 19A and 19B, the multiple substantially concentric ellipsoid reflectors 400aa, 400bb, 400nn may include multiple reflecting surfaces 440 for reflecting light from the light source 410 onto the area of interest 420.

In the embodiment shown FIG. 19A, the collapsed ellipsoid reflector 430 may include an aperture 450 (schematically indicated by dotted lines) for viewing the area of interest 420 along an axis of observation 455 that extends through the aperture 450. Optionally, the illumination system 400 may include optics for observing the area of interest 420. For example, as shown, the illumination system 400 may include a microscope objective lens 460.

In the embodiment shown in FIG. 19A, the multiple reflecting surfaces 440 of the collapsed ellipsoid reflector 430 may be arranged in the substantially concentric ellipsoidal pattern previously described herein, and the light source 410 may be disposed near the point of divergence of the concentric ellipsoidal pattern, for example, near the first shared focus. In this embodiment, light rays 406 that emanate from the light source 410 and that strike the collapsed ellipsoid reflector 430 can be reflected as light rays 408 by the multiple reflecting surfaces 440. The reflected light rays 408 converge onto the area of interest 420 disposed near the point of convergence of the concentric ellipsoidal pattern, for example, near the second shared focus, to provide a large solid angle of substantially uniform incident illumination for the area of interest 420.

As shown in FIGS. 19A and 19B, the collapsed ellipsoid reflector 430 may include one or more reflecting surfaces 440, 442, 444, 446 having a curvature for reflecting illumination from the light source 410 onto the area of interest 420. Alternatively, as described above, the collapsed ellipsoid reflector 430 may include one or more flat reflecting surfaces (not shown) for reflecting illumination from the light source 410 onto the area of interest 420.

FIG. 19C shows a perspective view of the reflective surface of the collapsed ellipsoid reflector 430 shown in FIGS. 19A and 19B. As shown in FIG. 19C, the collapsed ellipsoid reflector 430 may have a substantially rectangular format, and may include an asymmetrical viewing aperture 450. As also shown in FIG. 19C, the collapsed ellipsoid reflector 430 may include multiple substantially concentric ellipsoid reflectors 400aa, 400bb, and 400nn that share common foci, that is, common points of divergence and convergence.

As shown in FIG. 19A, the collapsed ellipsoid reflector 430 may include one or more concave reflecting surfaces 446 having a width 446a so that reflected light rays 408 extend at least across the width 424 of the area of interest 420. As shown in the figure, in this embodiment, the collapsed ellipsoid reflector 430 generates a focused distribution of reflected illumination across the area of interest 420.

The distribution of reflected illumination generated by the collapsed ellipsoid reflector 430 may be attributed to at least two physical features. These physical features include the reflective properties of the concave reflecting surfaces 440 and the reflective properties of the substantially concentric ellipsoidal arrangement of the concave reflecting surfaces 440.

A variety of schemes may be used to fabricate the collapsed ellipsoid reflector 430. For example, the collapsed ellipsoid reflector 430 may be constructed by suitably modifying the schemes previously described for fabricating the focusing panel shown in FIGS. 11-13 and 17. More specifically, the collapsed ellipsoid reflector 430 may be vacuum-formed over a mold including an array of square pins in which one or more square pins are ground at one end to have an appropriate curvature for reflecting illumination from the light source 410 onto the area of interest 420. In another embodiment, the collapsed ellipsoid reflector 430 may be constructed by first fabricating multiple concentric ellipsoid reflectors, and then attaching the multiple concentric ellipsoid reflectors to each other. The multiple concentric ellipsoid reflectors may be fabricated according to schemes described previously and may be attached to each other by using conventional schemes. For example, the multiple concentric ellipsoid reflectors may be attached by using an adhesive compatible with optical components. Alternately, the multiple concentric ellipsoid reflectors may be removeably and replaceably attached to each other by using conventional fasteners. Further, the multiple concentric ellipsoid reflectors may be constructed to be press-fitted to each other.

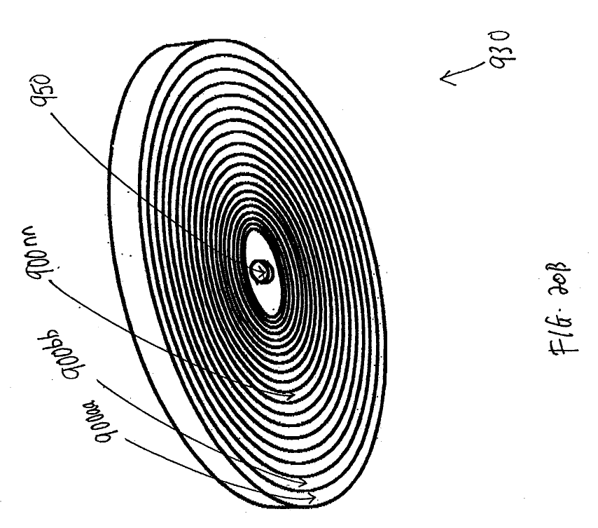

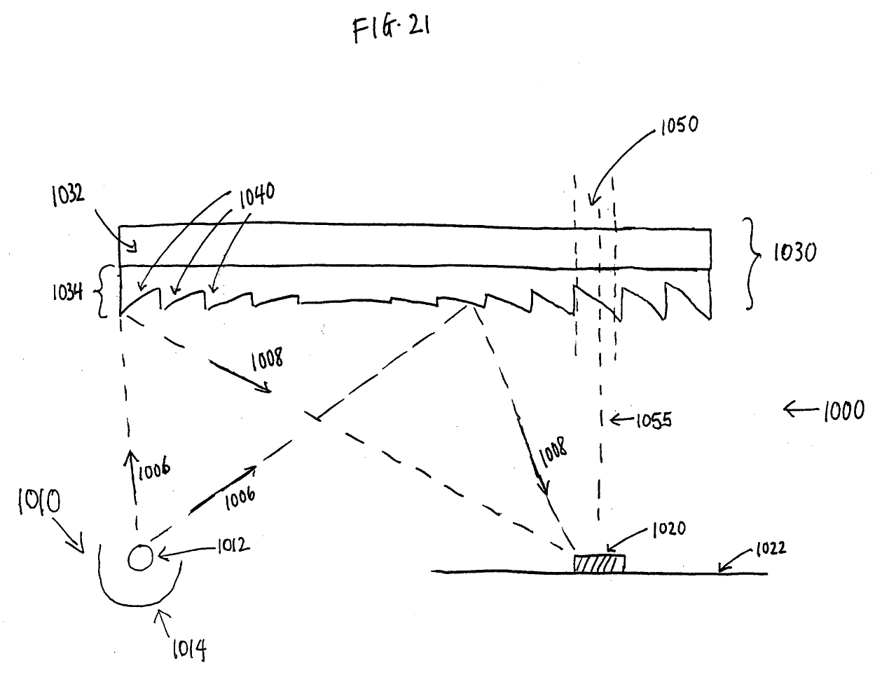

FIG. 20A shows a side view of an illumination system including a focusing panel according to one embodiment of the present invention. Operation of the illumination system shown in FIG. 20A is based on principles previously provided herein. As shown in FIG. 20A, an illumination system 900 may include a light source 910, an area of interest located on a worksurface 922, and a collapsed ellipsoid reflector 930 positioned to reflect light from the light source 910 onto the area of interest. As shown in FIG. 20A, the collapsed ellipsoid reflector 930 may include a symmetrically located aperture 950 (schematically indicated by dotted lines) for viewing the area of interest along an axis of observation 955 that extends through the aperture 950. As shown in FIG. 20A, the illumination system 900 provides symmetrical illumination of the area of interest around the observation axis 955. As further shown in FIG. 20A, the light source 910 may optionally be disposed on a moveable platform 916, so that the focal plane 980 of reflected light rays 908 may be adjusted by moving the light source 910. The illumination system 900 may provide focused illumination for a variety of applications. For example, as shown in FIG. 20A, the illumination system 900 may provide focused illumination of the area of interest to be observed by a microscope 960.

FIG. 20B shows a perspective view of the reflective surface of the focusing panel shown in FIG. 20A. As shown in FIG. 20B, the collapsed ellipsoid reflector 930 may have a substantially circular format, and may include a symmetrically located aperture 950. As further shown in FIG. 20B, the collapsed ellipsoid reflector 930 may include multiple substantially concentric ellipsoid reflectors 900aa, 900bb, and 900nn that share common foci.

As indicated above, a variety of constructions of the focusing panels disclosed herein are possible. For example, as shown in FIGS. 11-13 and 17, a focusing panel may be constructed to include one or more flat reflecting surfaces. Alternately, as shown in FIGS. 18-20, a focusing panel may be constructed to include one or more concave reflecting surfaces. Also alternately, a focusing panel may be constructed to include any combination of flat and concave reflecting surfaces.

As also indicated above, a variety of geometric arrangements of the multiple reflecting surfaces disposed on the focusing panels disclosed herein are possible. For example, as shown in FIGS. 11-13 and 17, the reflecting surfaces may be arranged in a substantially rectangular pattern. Alternately, the reflecting surfaces may be arranged in substantially polygonal, semi-oval, or oval patterns. Also alternately, as shown in FIGS. 18-20, the reflecting surfaces may be arranged in a substantially concentric ellipsoidal pattern sharing common points of divergence and convergence. For example, the reflecting surfaces may comprise a collapsed ellipsoid reflector. Also alternately, the reflecting surfaces may be arranged in a substantially ellipsoidal pattern having shared points of divergence and convergence. For example, the reflecting surfaces may comprise an ellipsoid reflector. Also alternately, the reflecting surfaces may be arranged in a substantially concentric pattern having a shared center. For example, the reflecting surfaces may comprise a spheroid reflector.

A variety of optical devices are compatible with the illumination systems disclosed herein. For example, the illumination systems disclosed herein may include cameras, microscopes, and/or other conventional optical devices that include one or more lenses. Also, the illumination systems disclosed herein may include focusing panels having one or more apertures, and the one or more apertures may be symmetrically or asymmetrically located in the focusing panels. Additionally, the illumination systems disclosed herein may include one or more light sources disposed on moveable platforms.

FIG. 21 shows a side view of an illumination system including a focusing panel in accordance with one embodiment of the present invention. As shown, an illumination system 1000 may include a light source 1010, an area of interest 1020 located on a worksurface 1022, and a reflector 1030 positioned to reflect light from the light source 1010 onto the area of interest 1020. As also shown, the reflector 1030 may include a reflective surface 1032 and a film 1034 having multiple segments 1040 arranged in a geometric pattern for reflecting light from the light source 1010 onto the area of interest 1020. As further shown, the reflector 1030 may include an aperture 1050 (schematically indicated by dotted lines) for viewing the area of interest 1020 along an axis of observation 1055 that extends through the aperture 1050. Optionally, the illumination system 1000 may include optics (not shown) for observing the area of interest 1020.

Operation of the reflector 1030 is based on principles previously provided herein. In the embodiment shown in FIG. 21, the multiple segments 1040 of the film 1034 are arranged in the substantially concentric ellipsoidal pattern previously described herein. Also, in the embodiment shown in FIG. 21, the light source 1010 is disposed near the point of divergence of the substantially concentric ellipsoidal pattern, for example, near the first shared focus. In this embodiment, light rays 1006 that emanate from the light source 1010 and that strike the reflector 1030 can be reflected by the reflective surface 1032 through the segments 1040 as light rays 1008. The reflected light rays 1008 converge onto the area of interest 1020 disposed near the point of convergence of the substantially concentric ellipsoidal pattern, for example, near the second shared focus, to provide a large solid angle of substantially uniform incident illumination for the area of interest 1020.

A variety of schemes may be used to fabricate the reflector 1030. For example, the film 1034 and the multiple segments 1040 may comprise a conventional hologram, and may be fabricated by using conventional holographic schemes. As suggested above, the multiple segments 1040 may be arranged in a wide variety of different geometric arrangements. For example, the multiple segments may be arranged in substantially polygonal, semi-oval, oval, concentric, ellipsoidal, or concentric ellipsoidal patterns. As also suggested above, the multiple segments 1040 may include one or more flat surfaces, one or more concave surfaces, or any combination of flat and concave surfaces. The reflective surface 1032 may comprise a mirror or another conventional reflective surface. The film 1034 may be attached to the reflective surface 1032 by using conventional schemes. For example, the film 1032 may be attached by using an adhesive compatible with optical components. Alternately, the film 1034 may be removeably and replaceably attached to the reflective surface 1032 by using conventional fasteners.

Based on the foregoing discussion, an exemplary method of illuminating an area of interest may include identifying an area of interest, providing a light source, and providing a reflector for reflecting light from the light source onto the area of interest. In one embodiment, the reflector may include multiple reflecting surfaces arranged in a geometric pattern such that light reflected from the multiple reflecting surfaces converges onto the area to provide a large solid angle of substantially uniform incident illumination for the area. In another embodiment, the reflector may include a film that includes multiple segments arranged in a geometric pattern such that light reflected from the reflector through the segments converges onto the area to provide a large solid angle of substantially uniform incident illumination for the area.

In one aspect, the exemplary method may include identifying a point of convergence of the geometric pattern, and positioning the reflector such that the point of convergence is proximate to the area of interest.

In another aspect, the exemplary method may include identifying a point of divergence of the geometric pattern, and positioning the light source such that light passes through the point of divergence.

In another aspect, the exemplary method may include activating the light source to illuminate the area of interest.

Positioning the light source and the reflector in the manner previously specified and then activating the light source may tend to generate a focused distribution of reflected illumination passing through the point of convergence, thereby providing a large solid angle of substantially uniform incident illumination for the area of interest.

Since certain changes may be made in the above described illumination devices, without departing from the spirit and scope of the invention herein involved, it is intended that all of the subject matter of the above description or shown in the accompanying drawings shall be interpreted merely as examples illustrating the inventive concept herein and shall not be construed as limiting the invention.

1. A system for illuminating an area of interest, the system comprising:
a light source,
a reflector for reflecting light from the light source onto an area of interest, and
multiple reflecting surfaces disposed on the reflector and arranged in a geometric pattern such that light reflected therefrom converges onto the area to provide a solid angle of substantially uniform incident illumination sufficient to allow the area to appear uniformly illuminated.

2. The system of claim 1, wherein at least one reflecting surface has a first extent so that light reflected therefrom extends at least across the width of the area to provide a substantially uniform level of illumination thereat.

3. The system of claim 1, wherein the geometric pattern includes a substantially ellipsoidal arrangement.

4. The system of claim 3, wherein the substantially ellipsoidal arrangement includes a point of convergence, such that light reflected from a reflecting surface converges through the point of convergence.

5. The system of claim 4, wherein the substantially ellipsoidal arrangement includes a point of divergence, such that light incident on a reflecting surface from the point of divergence converges through the point of convergence.

6. The system of claim 1, wherein the geometric pattern includes a substantially concentric arrangement.

7. The system of claim 6, wherein the substantially concentric arrangement includes a substantially concentric ellipsoidal arrangement.

8. The system of claim 7, wherein the substantially concentric ellipsoidal arrangement together includes a point of convergence, such that light reflected from a reflecting surface in an ellipsoid in the substantially concentric arrangement converges through the point of convergence.

9. The system of claim 8, wherein the substantially concentric ellipsoidal arrangement together includes a point of divergence, such that light incident on a reflecting surface in an ellipsoid in the substantially concentric ellipsoidal arrangement from the point of divergence converges through the point of convergence.

10. The system of claim 1, wherein at least one of the multiple reflecting surfaces includes a flat surface.

11. The system of claim 1, wherein at least one of the multiple reflecting surfaces includes a curved surface.

12. A system for illuminating an area of interest, the system comprising:
a light source,
a reflector for reflecting light from the light source onto an area of interest, and
a film disposed on the reflector, the film having multiple segments arranged in a geometric pattern such that light reflected from the reflector through the multiple segments converges onto the area to provide a solid angle of substantially uniform incident illumination sufficient to allow the area to appear uniformly illuminated.

13. The system of claim 12, wherein at least one segment has a first extent so that light reflected through the at least one segment extends at least across the width of the area to provide a substantially uniform level of illumination thereat.

14. The system of claim 12, wherein the geometric pattern includes a substantially ellipsoidal arrangement.

15. The system of claim 14, wherein the substantially ellipsoidal arrangement includes a point of convergence, such that light reflected through a segment converges through the point of convergence.

16. The system of claim 15, wherein the substantially ellipsoidal arrangement includes a point of divergence, such that light incident on the reflector from the point of divergence converges through the point of convergence.

17. The system of claim 12, wherein the geometric pattern includes a substantially concentric arrangement.

18. The system of claim 17, wherein the substantially concentric arrangement includes a substantially concentric ellipsoidal arrangement.

19. The system of claim 18, wherein the substantially concentric ellipsoidal arrangement together includes a point of convergence, such that light reflected through a segment in an ellipsoid in the substantially concentric arrangement converges through the point of convergence.

20. The system of claim 19, wherein the substantially concentric ellipsoidal arrangement together includes a point of divergence, such that light incident on the reflector from the point of divergence converges through the point of convergence.

21. A method of illuminating an area of interest, the method comprising:
identifying an area of interest,
providing a light source, and
providing a reflector for reflecting light from the light source onto the area of interest, the reflector including multiple reflecting surfaces arranged in a geometric pattern such that light reflected therefrom converges onto the area to provide a solid angle of substantially uniform incident illumination sufficient to allow the area to appear uniformly illuminated.

22. The method of claim 21, further comprising:
activating the light source to illuminate the area of interest.

23. The method of claim 21, further comprising:
identifying a point of convergence of the geometric pattern, and
positioning the reflector such that the point of convergence is positioned proximate to the area.

23. The method of claim 21, further comprising:
identifying a point of divergence of the geometric pattern, and
positioning the light source such that light passes through the point of divergence.

24. A method of illuminating an area of interest, the method comprising:
identifying an area of interest,
providing a light source, and
providing a reflector for reflecting light from the light source onto the area of interest, the reflector including a film including multiple segments arranged in a geometric pattern such that light reflected from the reflector through the segments converges onto the area to provide a solid angle of substantially uniform incident illumination sufficient to allow the area to appear uniformly illuminated.

25. The method of claim 24, further comprising:
activating the light source to illuminate the area of interest.

26. The method of claim 24, further comprising:
identifying a point of convergence of the geometric pattern, and
positioning the reflector such that the point of convergence is positioned proximate to the area.

27. The method of claim 25, further comprising:
identifying a point of divergence of the geometric pattern, and
positioning the light source such that light passes through the point of divergence.

28. A method of fabricating reflecting surfaces for illuminating an area of interest, the method comprising:
providing reflecting surfaces; and,
shaping the reflecting surfaces such that light reflected from the reflecting surfaces converges onto the area to provide a solid angle of substantially uniform incident illumination sufficient to allow the area to appear uniformly illuminated

29. The method of claim 28, wherein providing the reflecting surfaces comprises:
forming the reflecting surfaces over a mold.

30. The method of claim 28, wherein shaping the reflecting surfaces comprises:
grinding at least one of the reflecting surfaces to include at least one of a flat surface and a curved surface.

31. The method of claim 28, wherein shaping the multiple reflecting surfaces comprises:
arranging the reflecting surfaces in a geometric pattern including at least one of a substantially ellipsoidal arrangement, a substantially concentric arrangement, and a substantially concentric ellipsoidal arrangement.

32. A device for viewing an object, comprising:
a housing;
a camera, disposed in the housing, for receiving an image of the object and transmitting a signal corresponding to the image;
focusing optics associated with the camera;
an illumination source; and
a focusing panel, positioned at a location spaced apart from the illumination source, for reflecting a solid angle of substantially uniform incident illumination sufficient to allow the object to appear uniformly illuminated.

33. The device of claim 32, wherein the focusing panel is a faceted reflector.

34. The device of claim 33, wherein the focusing panel is movable.

35. The device of claim 34, wherein the illumination source is movable.

36. A device for viewing an object, comprising:
an illumination source; and
a reflector, positioned at a location spaced apart from the illumination source, having a plurality of reflecting surfaces oriented for reflecting a solid angle of substantially uniform incident illumination sufficient to allow the object to appear uniformly illuminated.

37. The device of claim 36, wherein the plurality of reflecting surfaces comprise a faceted reflector.

38. The device of claim 36, wherein the reflector comprises a thermo-formed plastic sheet.

39. The device of claim 36, wherein the reflector is formed from a mold.

40. The device of claim 36, further comprising pins of such faceted reflector for reflecting light in a variety of directions.

41. The device of claim 39, wherein the mold comprises an array of pins.

42. The device of claim 41, wherein each pin is ground to provide an appropriate angle and orientation.

43. A method of providing an illumination source for an object, comprising:
determining the specularity of the object;
determining an acceptable defect size in the uniformity of the illumination field; and
providing an illumination geometry having defect size less than the acceptable defect size.

44. The method of claim 43, wherein the illumination geometry comprises a focusing panel.

45. The method of claim 43, wherein the illumination geometry comprises a faceted dome.

46. The method of claim 43, wherein the illumination geometry is a continuous diffuse illumination geometry.

47. A method of image processing, comprising:
providing an illuminating source;
providing a faceted focusing panel for reflecting light in a plurality of directions from the illumination source to an object to be viewed;
providing an electronic camera for viewing the object;
providing a vision processor for processing data from the electronic camera; and
providing a computer for storing, manipulating and retrieving data from the vision processor.

48. The method of claim 47, wherein the computer controls a process based on the data.

49. The method of claim 48, wherein the process is a manufacturing process.

50. The method of claim 48, wherein the process is an inventory control process.

51. A vision system for viewing an object, comprising:
an electronic machine vision camera for receiving an image of an object and transmitting data corresponding to the image;
an illumination source;
a faceted focusing panel, positioned at a location spaced apart from the illumination source, for reflecting a solid angle of substantially uniform incident illumination in a plurality of directions from the illumination source sufficient to allow the object to appear uniformly illuminated;
an image processor, for receiving the data from the camera and generating data corresponding to the signal; and
a computer, for receiving, storing, manipulating and retrieving data from the image processor.

52. The system of claim 51, wherein the computer controls a process based on the data.

53. The method of claim 52, wherein the process is a manufacturing process.

54. The method of claim 52, wherein the process is an inventory control process.

55. A device for viewing an object, the device comprising:
an illumination source,
a panel, positioned at a location spaced apart from the illumination source, for reflecting illumination from the illumination source to the object, and
a faceted reflecting surface on a side of the panel proximate to the source for generating a solid angle of substantially uniform incident illumination onto the object from multiple angles of incidence.

56. The device of claim 55, wherein illumination from the illumination source includes a first solid angle, and illumination reflected from the reflecting surface includes a second solid angle greater than the first solid angle.
